(19) United States
(12) Patent Application Publication
(10) Pub. No.: US 2013/0227106 A1
(43) Pub. Date: Aug. 29, 2013

(54) METHOD AND APPARATUS FOR VIDEO SESSION MANAGEMENT

(71) Applicants: Edward Grinshpun, Freehold, NJ (US); David Faucher, Guthrie Center, IA (US); Sameerkumar V. Sharma, Holmdel, NJ (US); Paul A. Wilford, Bernardsville, NJ (US)

(72) Inventors: Edward Grinshpun, Freehold, NJ (US); David Faucher, Guthrie Center, IA (US); Sameerkumar V. Sharma, Holmdel, NJ (US); Paul A. Wilford, Bernardsville, NJ (US)

(21) Appl. No.: 13/731,791

(22) Filed: Dec. 31, 2012

Related U.S. Application Data
(60) Provisional application No. 61/602,547, filed on Feb. 23, 2012.

(51) Int. Cl. H04L 12/24

(52) U.S. Cl. CPC H04L 41/32
USPC 709/223

(57) ABSTRACT

A video session management capability provides network-directed, client-assisted management of real-time mobile video sessions of video clients of mobile devices. The video session management capability is provided using a mobile device accessing a Wireless Service Provider (WSP) network and a video management server associated with the WSP network. The mobile device includes a video client and a video control engine. The video control engine collects client information at the mobile device and provides the client information to the video management server. The video management server receives the client information, obtains network information associated with the WSP network, determines video session management information, and propagates the video session management information toward the mobile device. The mobile device receives the video session management information and the video control engine uses the video session management information to manage a real-time mobile video session of the video client of the mobile device.

### CROSS REFERENCE TO RELATED APPLICATION

This application claims the benefit of U.S. Provisional Patent Application Ser. No. 61/602,547, entitled “METHOD AND APPARATUS FOR MOBILE VIDEO SESSION MANAGEMENT,” filed Feb. 23, 2012, which is hereby incorporated herein by reference in its entirety.

### TECHNICAL FIELD

The invention relates generally to video sessions and, more specifically but not exclusively, to mobile video session management.

### BACKGROUND

In existing communication networks, video sessions are established for video clients of user devices, e.g., video session between video servers in the communication network and video clients of user devices and peer-to-peer video sessions between video clients of user devices.

### SUMMARY OF EMBODIMENTS

Various deficiencies in the prior art are addressed by embodiments for providing video session management.

In one embodiment, an apparatus is configured for use as or at a mobile device including a Hypertext Transfer Protocol (HTTP) Adaptive Streaming (HAS) client. The apparatus includes a processor and a memory communicatively connected to the processor. The processor is configured to propagate, from a mobile device toward a network server, a HAS registration request of a HAS control engine of the mobile device, where the HAS control engine is configured to support the HAS client of the mobile device, and where the HAS registration request relates to a HAS video session requested by the HAS client of the mobile device. The processor is configured to propagate, from the mobile device toward the network server, HAS manifest information of a HAS manifest file related to the requested HAS video session and client information related to the HAS video session that is obtained at the mobile device. The processor is configured to receive, at the HAS control engine of the mobile device from the network server, an indication of a recommended bitrate calculated for the HAS video session by the network server using the HAS manifest information, the client information, and network information related to the requested HAS video session obtained by the network server.

In one embodiment, an apparatus is configured to support Hypertext Transfer Protocol (HTTP) Adaptive Streaming (HAS) sessions. The apparatus includes a processor and a memory communicatively connected to the processor. The processor is configured to receive, at a network server, a HAS registration request from a HAS control engine of a mobile device supporting a HAS client, where the HAS registration request relates to a HAS video session requested by the HAS client of the mobile device. The processor is configured to receive, at the network server, HAS manifest information of a HAS manifest file related to the requested HAS video session and client information related to the HAS video session that is obtained at the mobile device. The processor is configured to receive, at the network server, network information related to the requested HAS video session. The processor is configured to calculate, at the network server, a bitrate for the requested HAS video session, where the bitrate is calculated using the HAS manifest information, the client information, and the network information. The processor is configured to propagate an indication of the calculated bitrate from the network server toward the mobile device for use by the HAS client with the requested HAS video session.

In one embodiment, an apparatus is configured for use as or at a mobile device including a Hypertext Transfer Protocol (HTTP) Adaptive Streaming (HAS) client. The apparatus includes a processor and a memory communicatively connected to the processor. The processor is configured to receive, at the mobile device, a bitrate calculated for the HAS client by a network server associated with a network configured to provide wireless access to the mobile device. The processor is configured to adjust a Rate Determination Algorithm (RDA) of the HAS client using the received bitrate. The processor is configured to run the adjusted RDA of the HAS client to determine a bitrate for a HAS session of the HAS client.

In one embodiment, an apparatus is configured for use as or at a mobile device including a Hypertext Transfer Protocol (HTTP) Adaptive Streaming (HAS) client. The apparatus includes a processor and a memory communicatively connected to the processor. The processor is configured to receive, from the HAS client, a notification of intent of the HAS client to request a next video segment for a HAS session of the HAS client and at least one parameter associated with the next video segment to be requested. The processor is configured to propagate the notification and the at least one parameter from the mobile node toward a wireless access node configured to provide wireless access to the mobile device. The processor is configured to receive, at the mobile device from the wireless access node, a scheduled request time indicative of a time at which the HAS client is to request the next video segment.

### BRIEF DESCRIPTION OF THE DRAWINGS

The teachings herein can be readily understood by considering the following detailed description in conjunction with the accompanying drawings, in which:

FIG. 1 depicts a high-level block diagram of a system configured to manage video sessions over a cellular network;

FIG. 2 depicts one embodiment of a method for managing real-time mobile video sessions on a mobile device using interaction between the mobile device and a WSP network;

FIG. 3 depicts a high-level block diagram of a system configured to manage cooperating HAS video sessions over a cellular network;

FIG. 4 depicts one embodiment of a method for providing cooperative video bitrate and session parameter selection for a HAS video session;

FIG. 5 depicts an exemplary embodiment for providing for pacing of downlink video segments via scheduling of the video segment requests;

FIG. 6 depicts a high-level control loop diagram for a system configured to manage video sessions over a cellular network; and

FIG. 7 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

A video session management capability is depicted and described herein, although it will be appreciated that various other capabilities also may be presented herein.

In at least some embodiments, the video session management capability enables management of a real-time mobile video session established for a mobile device that is connected via a wireless service provider (WSP) network (e.g., between a video server available via the Internet and a video client on the mobile device, between a video client on the mobile device and a video client on a peer mobile device, or the like). The WSP network may be a WSP cellular network (e.g., a Second Generation (2G) cellular network, a Third Generation (3G) cellular network, a Long Term Evolution (LTE) Fourth Generation (4G) cellular network, or the like), a WSP Wireless Fidelity (WiFi) network, or any other suitable type of wireless service provider network. The real-time mobile video sessions may include live mobile video sessions (e.g., live video calls, video conferencing, video gaming applications, or the like), Hypertext Transfer Protocol (HTTP) Adaptive Streaming (HAS) mobile video sessions (e.g., for live streaming of television programs, movies, and other video content), or the like, as well as various combinations thereof.

In at least some embodiments, the video session management capability is a network-directed, client-assisted capability enabling WSP management of (and, in at least some cases, control over) mobile video traffic. In at least some embodiments, the mobile device includes a client middleware agent configured to support (1) internal interfaces to other components/elements/applications of the mobile device for collecting client information relevant for a real-time mobile video session at the mobile device and for managing optimizing quality of experience for the real-time mobile video session at the mobile device in a manner tending to improve (and, in at least some cases, optimize) Quality of Experience (QoE) for the real-time mobile video session at the mobile device, and (2) network interfaces to one or more elements of the serving WSP network for (2a) providing the collected client information to one or more elements of the WSP network for use by the WSP network in determining dynamic video session management information for use by the mobile device in managing real-time mobile video sessions (thereby enabling the WSP network to manage, and in at least some cases control, delivery of the real-time mobile video session to the mobile device), and for (2b) receiving the dynamic video session management information that is provided by the WSP network for use by the mobile device in managing the real-time mobile video session. In this manner, network-directed, client-assisted management of the real-time mobile video session of the mobile device may improve mobile video quality consistency and, thus, enable new video applications and services.

In at least some embodiments, a client middleware agent of a mobile device associated with a WSP network and a video session management element of the WSP network are configured to provide respective functions for enabling network-directed, client-assisted management of (and, in at least some cases, control over) the real-time mobile video session of the mobile device. In at least some embodiments, for example, the client middleware agent of the mobile device and video session management element of the WSP network may be configured as follows: (1) the client middleware agent is configured to collect a wealth of client information available at the mobile device and share the collected client information with various functions within the WSP network via one or more interfaces between the client middleware agent and various real-time mobile video session management/control elements in the WSP network (including the video session management element) (2) the video session management element in the WSP network is configured to determine video session management information for use by the mobile device in managing (and, in at least some cases, controlling) the real-time mobile video session on the mobile device using the client information and network information collected by the video session management element from the WSP network and, further, to provide the video session management information to the client middleware agent via one or more interfaces between the video session management element and the client middleware agent, and (3) the client middleware agent is configured to receive the video session management information and use the video session management information to manage the real-time mobile video session at the mobile device. It will be appreciated that the client middleware agent may be implemented using one or more engines and/or modules disposed on the mobile device. Similarly, it will be appreciated that the video session management element may be implemented using one or more management systems, one or more management engines disposed on one or more existing and/or new nodes of the WSP network, one or more servers, or the like, as well as various combinations thereof). In at least some embodiments, the client middleware agent of the mobile device and the video session management element of the WSP network are configured to operate in a manner tending to provide quality improvement and optimization.

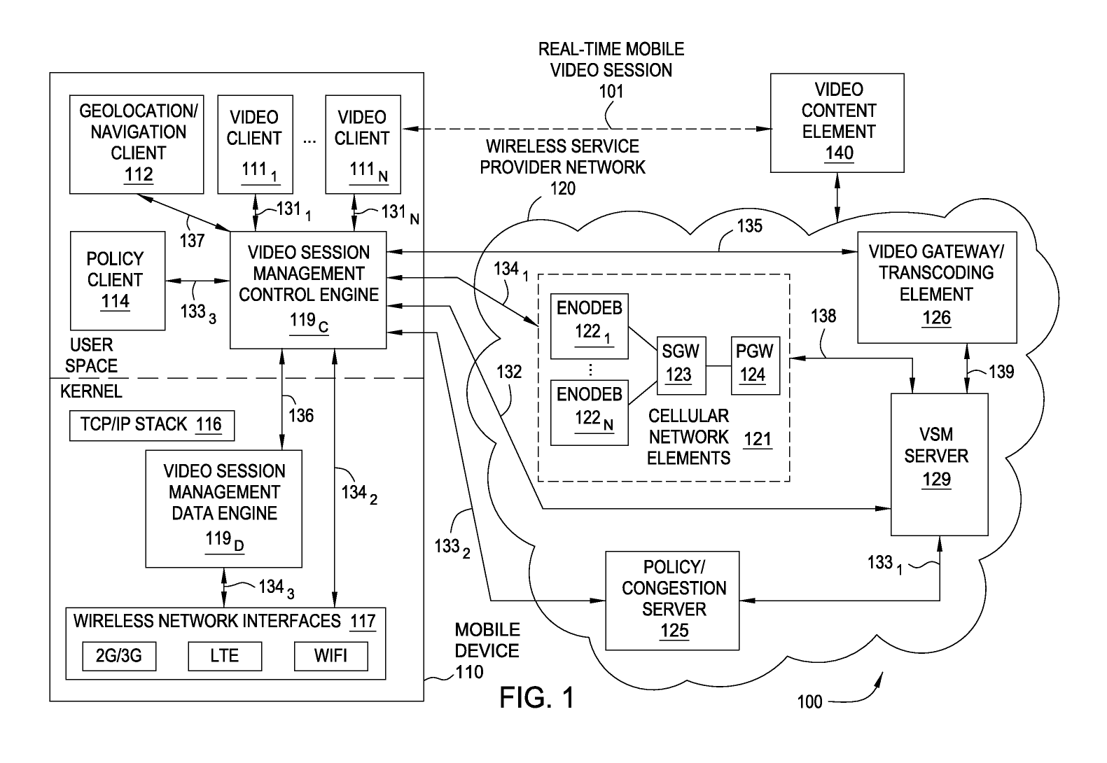

Various embodiments of the video session management capability may be better understood by considering FIG. 1-FIG. 6 depicted and described herein.

It will be appreciated that, although primarily depicted and described herein within the context of use of the video session management capability to manage real-time mobile video sessions delivered to a mobile device via a cellular WSP network, various embodiments of video session management capability also may be used to manage other types of video sessions, to manage video sessions delivered to other types of devices, and/or to manage video sessions delivered via other types of WSP networks.

FIG. 1 depicts a high-level block diagram of a system configured to manage video sessions over a cellular network.

As depicted in FIG. 1, system 100 includes a mobile device 110, a wireless service provider (WSP) network 120, and a video content element 140.

The system 100 is configured to support transport of video content between mobile device 110 and video content element 140. This may include downlink transport of video content from video content element 140 to mobile device 110 and/or uplink transport of video content from mobile device 110 to video content element 140.

In at least some embodiments, for server-to-peer applications, system 100 only provides downlink transport of video content from video content element 140 to mobile device 110. In this case, video control element 140 is a server that provides video content to mobile device 110 (e.g., a HAS server or any other suitable type of video server).

In at least some embodiments, for peer-to-server-to-peer applications, system 100 provides downlink transport of video content from video content element 140 to mobile device 110 and provides uplink transport of video content from mobile device 110 to video content element 140. In at least some such embodiments, video content element 140 may be an intermediate server that is configured to receive video content from one or more peers of mobile device 110 and provide the video content to mobile device 110 and, similarly, to receive video content from mobile device 110 and distribute it to one or more peers of mobile device 110. It will be appreciated that the peers of mobile device 110 may be one or more wireless and/or wireline devices.

In at least some embodiments, for peer-to-peer applications, system 100 provides downlink transport of video content from video content element 140 to mobile device 110 and provides uplink transport of video content from mobile device 110 to video content element 140. In at least some such embodiments, video control element 140 is a peer of mobile device 110 (e.g., a wireless user device, a wireline user device, or the like).

It will be appreciated that video content element 140 may be configured to support multiple such application types (e.g., operating as an end server for server-to-peer applications and operating as an intermediate server for peer-to-server-to-peer applications).

It will be appreciated that system 100 may include multiple video content elements 140 (e.g., one or more end servers, one or more intermediate servers, one or more peers of mobile device 110, or the like, as well as various combinations thereof).

The mobile device 110 may be any suitable type of device configured to communicate via one or more types of wireless networks, e.g., one or more types of cellular network (e.g., 2G/3G cellular networks, LTE 4G cellular networks, or the like), WiFi networks, or the like. For example, mobile device 110 may be a cellular phone, a smartphone, a tablet computer, a laptop computer, or the like.

The mobile device 110 software/firmware includes a user space and a kernel, each of which includes various components, elements, and/or engines supporting various capabilities of the mobile device 110. More specifically, the mobile device 110 includes a plurality of video clients 111₁-111_{N} (collectively, video clients 111), a geolocation/navigation client 112, a policy client 114, a Transmission Control Protocol (TCP)/Internet Protocol (IP) stack 116, a plurality of wireless network interfaces (WNIs) 117, and a Video Session Management (VSM) Engine 119 composed of a VSM Control Engine (VCE) 119_{C} and a VSM Data Engine (VDE) 119_{D}.

The video clients 111, geolocation/navigation client 112, policy client 114, and VCE 119_{C} may be associated with the user space of mobile device 110. The video clients 111 are configured to support real-time mobile video (e.g., live video, HAS video, or the like). For example, video clients 111 may include one or more live video clients configured to support live video sessions (e.g., video clients configured to support live video calls, live video conferencing, or the like), one or more HAS video clients configured to support HAS video sessions (e.g., for live streaming of movies and/or other previously encoded video content), or the like, as well as various combinations thereof. The geolocation/navigation client 112 may be any type of client configured to support geolocation and, optionally, navigation functions on the mobile device 110. The policy client 114 is configured to obtain and/or store policy information, at least a portion of which may be obtained from one or more elements of WSP network 120. The VCE 119_{C} is configured to support management of (and, in at least some cases, control over) real-time mobile video sessions of video clients 111.

The TCP/IP stack 116, WNIs 117, and VDE 119_{D} may be associated with the kernel of mobile device 110. The typical operation of TCP/IP stack 116 and WNIs 317 will be understood. Although depicted as including specific numbers/types of WNIs 117 (including cellular WNIs and a WiFi WNI), it will be appreciated that the mobile device 110 may include fewer or more WNIs and/or one or more other types of WNIs. The VDE 119_{D} is configured to support management of (and, in at least some cases, control over) real-time mobile video sessions of video clients 111. It will be appreciated that the various components, elements, and/or engines may be disposed across the user space and kernel of the mobile device 110 in any other suitable manner and/or may be arranged using any other suitable organization of spaces and/or other portions of the mobile device 110.

It will be appreciated that, although depicted and described with respect to an exemplary mobile device 110 having a specific type of architecture (e.g., including an operating system configured to include a user space and a kernel, each having specific modules/engines), the architecture of the mobile device 110 may be designed in any other suitable manner (e.g., using any other suitable type of operating system architecture). For example, the distribution of the various modules/engines across the user space and the kernel may be different. For example, the mobile device 110 may be configured such that it does not include a user space. Other arrangements are contemplated.

It will be appreciated that, although depicted and described with respect to an exemplary mobile device 110 having a specific combination of client modules, mobile device 110 may include fewer or more (as well as different) client modules. For example, the client device 110 may include only a single video client 111. For example, the client device 110 may exclude geolocation/navigation client 112 and/or policy client 114. Other sets of clients are contemplated.

It will be appreciated that mobile device 110 may include various other components, elements, and/or engines supporting other types of functions typically performed by mobile devices, at least a portion of which also may be utilized for providing various functions of the video session management capability.

The WSP network 120 may be any suitable type of wireless network, e.g., a cellular network (e.g., a 2G cellular network, a 3G cellular network, an LTE 4G network, or the like), a WiFi network, or the like. In the exemplary embodiment of FIG. 1, the WSP network 120 is depicted as an LTE cellular network (although various embodiments depicted and described herein are applicable to other types of networks, such as other types of cellular networks (e.g., 2G cellular networks, 3G cellular networks, beyond 4G cellular networks, or the like), WiFi networks, or the like).

The WSP network 120 includes cellular network elements 121 configured to support control and bearer sessions for WSP network 120, a policy/congestion server 125, a video gateway/transcoding element (VGTE) 126, and a VSM server 129.

The cellular network elements 121, given that in this example WSP network 120 is implemented as an LTE cellular network, include a plurality of eNodeBs 122₁-122_{N} (collectively, eNodeBs 122), a Serving Gateway (SGW) 123, and a Packet Data Network (PDN) Gateway PGW 124. Similarly, given that in this example WSP network 120 is an LTE cellular network, the policy/congestion server 125 may be implemented as/using a 3GPP Access Network Discovery And Selection Function (ANDSF) function.

The VGTE 126 may be configured to provide one or more of video services, video transcoding mechanisms, or the like, as well as various combinations thereof. For example, VGTE 126 may be configured to provide video services such as live video services (e.g., video calling and/or video conference services), video content interaction services, or the like, as well as various combinations thereof. For example, VGTE 126 may be configured to provide video transcoding mechanisms for transcoding video received at VGTE 126 (e.g., received from one or more video sources available via the Internet) and/or VGTE 126 may be configured to perform video filtering functions for Scalable Video Coding (SVC) content. It will be appreciated that VGTE 126 may be deployed in any suitable location of the WSP network 120 (e.g., in the access network, in the core network, co-located with the VSM server 129, or the like).

The VSM server 129 is configured to cooperate with VSM Engine 119 to provide various functions of the video session management capability. The VSM 129 may provide video session management functions for mobile device 110 when mobile device 110 receives video content from one or more video sources.

The system 100 includes a number of interfaces in support of the video session management capability, some of which are internal to mobile device 110, some of which are internal to WSP network 120, and some of which are established between mobile device 110 and WSP network 120. The interfaces include a plurality of video client interfaces 131₁-131_{N} (collectively, video client interfaces 131) between the video clients 111₁-111_{N} and VCE 119_{C}, a VSM interface 132 between VCE 119_{C} and VSM server 129, a set of user/session policy interfaces 133 (including a first user/session policy interface 133₁ between policy/congestion server 125 and VSM server 129, a second user/session policy interface 133₂ between policy/congestion server 125 and VCE 119_{C}, and a third user/session policy interface 133₃ between VCE 119_{C} and policy client 114), a set of Radio Resource Control (RRC) interfaces 134 (illustratively, a network RRC interface 134₁ between VCE 119_{C} and cellular network elements 121, a first local RRC and wireless modem status and channel conditions interface 134₂ between VCE 119_{C} and WNIs 117, and a second local RRC and wireless modem status and channel conditions interface 134₃ between VDE 119_{D} and WNIs 117), an access/channel feedback interface 135 between VCE 119_{C} and VGTE 126, a throughput/channel status interface 136 between VCE 119_{C} and VDE 119_{D}, a geolocation/navigation interface 137 between VCE 119_{C} and geolocation/navigation client 112, a cooperative mobile devices connection/throughput status and scheduling control interface 138 between cellular network elements 121 and VSM server 129, and a gateway/transcoding control interface 139 between VGTE 126 and VSM server 129.

The video content element 140 is a source of video content which may be delivered to mobile device 110 via WSP network 120 and, in some cases, also may be a target of video content propagated from the mobile device 110 to the video content element 140 via WSP network 120.

In at least some embodiments, in the case of server-to-peer applications, video content element 140 propagates video content toward mobile device 110 via WSP network 120. In at least some such embodiments, for example, the video content element 140 may be a HAS video server (e.g., a NETFLIX server, a HULU server, or the like) or any other suitable type of video server.

In one embodiment, in the case of peer-to-server-to-peer applications, video content element 140 propagates video content toward mobile device 110 via WSP network 120 and receives video content from mobile device 110 via WSP network 120. In at least some such embodiments, for example, the video content element 140 may be an intermediate server supporting live video calling (e.g., a SKYPE server, FACETIME server, a GOOGLE server, or the like or any other suitable type of intermediate server supporting any suitable peer-to-peer service.

In at least some embodiments, in the case of peer-to-peer applications, video content element 140 propagates video content toward mobile device 110 via WSP network 120 and received video content from mobile device 110 via WSP network 120. For example, the video content element 140 may be a direct live video calling peer (e.g., another mobile device, a wireless device, a wireline device, or the like).

As depicted in FIG. 1, video content element 140 may be located outside of WSP network 120 and accessible via any suitable communication network(s) (e.g., via the Internet). Although primarily depicted and described herein with respect to an embodiment in which the video content element 140 is located outside of WSP network 120, it will be appreciated that the video content element 140 also could be located within WSP network 120 (e.g., in a content server, cache, or any other suitable type of content source) or in any other suitable location accessible to WSP network 120. Although primarily depicted and described herein with respect to a single video content element 140, it will be appreciated that multiple video content elements are available for providing video content to mobile device 110 as well as to other mobile devices served by WSP network 120.

The video content is delivered via a real-time mobile video session 101 between the mobile device 110 (illustratively, video client 111_{N} of mobile device 110) and the video content element 140. Although omitted for purposes of clarity, it will be appreciated that, within mobile device 110, the real-time mobile video session 101 may traverse a path typically traversed by video sessions in mobile devices. For example, in a downlink direction from WSP network 120 toward mobile device 110, the real-time mobile video session 101 may traverse a path from the WNIs 117 to TCP/IP stack 116 and from TCP/IP stack 116 to video client 111_{N}. Similarly, for example, in an uplink direction from mobile device 110 toward WSP network 120, the real-time mobile video session 101 may traverse a reverse path to that of the path described for the downlink direction. It is understood that this path may include various other elements and/or functions typically used to support video sessions in mobile devices (e.g., various other layers of the communications stack or the like). In at least some embodiments, as depicted in FIG. 1, the real-time mobile video session 101 also may include VDE 119_{D} disposed between TCP/IP stack 116 and WNIs 117. The VDE 119_{D} may be omitted from mobile device 110, or may be included within mobile device 110 such that it is transparent to the real-time mobile video session 101 except when providing one or more functions as depicted and described herein (e.g., taking measurements regarding the level of quality of the real-time mobile video session 101 for live video sessions and HAS video sessions, performing buffering of packets below the TCP layer for real-time mobile video session 101 in the case of HAS video sessions, or the like, as well as various combinations thereof).

The system 100 is configured to perform various functions enabling network-directed, client-assisted management of (and, in at least some cases, control over) real-time mobile video sessions, such as: (1) collecting, at the mobile device 110, client information related to the real-time mobile video session 101 at the mobile device 110, (2) sending the collected client information from the mobile device 110 to the WSP network 120 (e.g., to VSM server 129 of WSP network 120) for use by the WSP network 120 in determining video session management information, (3) receiving the collected client information at the VSM server 129 of the WSP network 120, (4) obtaining, at the VSM server 129 of the WSP network 120, network information related to real-time mobile video sessions of mobile devices served by the WSP network 120 (e.g., mobile device 110 and other mobile devices omitted for purposes of clarity), (5) determining, at VSM server 129 of the WSP network 120 using the client information and the network information, video session management information configured for use by the mobile device 110 in managing (and, in at least some cases, controlling) the real-time mobile video session 101, (6) providing the video session management information from the VSM server 129 of the WSP network 120 to the mobile device 110, (7) receiving the video session management information at the mobile device 110, and (8) managing (and, in at least some cases, controlling) the real-time mobile video session 101 at the mobile device 110 using the video session management information. It will be appreciated that the video session management and video session management information referenced herein also may be referred to as video session management and associated control and video session management and control information, dynamic video session management and associated dynamic video session management information, or the like.

Although primarily depicted and described with respect to embodiments in which information exchange is between the mobile device 110 and the VSM server 129, it will be appreciated that information collected at the mobile device 110 may be sent to any of the elements of WSP network 120 via any suitable interface(s) between mobile device 110 and WSP network 120 and, similarly, that video session management information may be determined by any of the elements of WSP network 120 and provided from any of the elements of the WSP network 120 to mobile device 110 via any suitable interface(s) between WSP network 120 and mobile device 110.

A description of various embodiments which may be supported by system 100 using various combinations of such functions (and, optionally, other functions) follows.

In a first embodiment, various elements of system 100 may be configured to management of and control over a real-time mobile video session of the mobile device 110.

In at least some embodiments, the mobile device 110 is configured to support management of and control over a real-time mobile video session of the mobile device 110. In at least some embodiments, VSM Engine 119 (which also may be referred to more generally as a video control engine) of the mobile device 110 is configured to support management of and control over a real-time mobile video session of mobile device 110. In at least some embodiments, VSM Engine 119 is configured to collect client information associated with a real-time mobile video session of a video client of the mobile device 110 (illustratively, real-time mobile video session 101), propagate the client information toward one or more elements of the WSP network 120 via one or more interfaces between the mobile device 110 and the one or more elements of the WSP network 120, receive video session management information determined by one or more elements of the WSP network 120 using the client information and network information associated with the WSP network 120, and initiate management of the real-time mobile video session using the video session management information. The client information may include one or more of geolocation information indicative of a geographic location of mobile device 110 (e.g., obtained from geolocation/navigation client 112), navigation information indicative of navigation related to mobile device 110 (e.g., obtained from geolocation/navigation client 112), signal quality information for mobile device 110, mobile device occupancy information for mobile device 110, mobile device battery level information for a battery of mobile device 110, mobile device screen size information for one or more display screens of mobile device 110, information shared by the video client 111 associated with the real-time mobile video session, or the like. The information shared by the video client may include one or more of available video session bit rate encodings, video segment information for a Hypertext Transfer Protocol (HTTP) adaptive streaming (HAS) session, at least one of security information and encryption keys information for a secure video session, a video camera capability of the video client 111 for a live video session, or the like. In at least some embodiments, the VSM Engine 119 may be configured to manage the real-time mobile video session of the video client of the mobile device using the video session management information by performing one of more of informing the video client of the mobile device of a bitrate to be used for the real-time mobile video session, informing the video client of the mobile device of at least one video session parameter to be used for the real-time mobile video session, and initiating interaction by the mobile device with one or more elements of the WSP network for controlling scheduling of packets of the real-time mobile video session.

In at least some embodiments, the VSM server 129 is configured to support management of and control over a real-time mobile video session of the mobile device 110 (illustratively, real-time mobile video session 101). In at least some embodiments, the VSM server 129 is configured to receive client information via a network interface between VSM server 129 and mobile device 110 (e.g., via VSM interface 132), obtain network information related to the real-time mobile video session of the mobile device 110, determine video session management information for mobile device 110 (e.g., for VSM Engine 119 of mobile device 110) using the client information and the network information, and propagate the video session management information toward the mobile device 110 via one or more network interfaces between the WSP network 120 and the mobile device 110 for use by the mobile device 110 in managing the real-time mobile video session. The VSM server 129 also may be configured to update the video session management information for the mobile device 110 as the associated input information changes and to monitor the video session management information for determining whether a change is detected in the video session management information for the mobile device 110. As noted above, the client information may include one or more of geolocation information, navigation information, signal quality information, mobile device occupancy information, mobile device battery level information, mobile device screen size information, information shared by the video client, or the like, as well as various combinations thereof. The network information may include at least one of serving cell load information indicative of the load on the cellular region serving the mobile device 110, mobile location information indicative of a location of the mobile device 110 (e.g., geographic location and/or network location), mobile movement information indicative of movement of the mobile device 110 (e.g., geographic movement and/or network-related movement), cell congestion information, network congestion information, wireless mobile conditions of one or more mobile devices, or the like, as well as various combinations thereof.

In such embodiments, the video session management information is adapted for use by the mobile device 110 to manage the real-time mobile video session 101 at mobile device 110. In at least some embodiments, for example, the video session management information for a real-time mobile video session may include one or more of a bitrate to be used for the real-time mobile video session, at least one video session parameter to be used for the real-time mobile video session, and information configured for use by the video client of the mobile device 310 to modify an associated rate determination algorithm (RDA).

In a second embodiment, the VSM Engine 119 is configured to enable WSP management of (and, in some cases, control over) live video sessions (e.g., live video calls, live video conferencing, gaming, or the like) with scalable video coding (SVC) to provide consistent quality of the mobile live video sessions.

The VCE 119_{C} obtains input information and processes the input information to convert the input information into feedback information. The input information may include local video session information, local location and mobility navigation information, policy information, wireless channel condition information, or the like. The VCE 119_{C} may be configured to process the input information to form the associated feedback information using one or more live video information analysis processes. The VCE 119_{C} may provide the feedback information to one or more of (1) the associated video client 111 on mobile device 110 via the associated video client interface 131, (2) the VSM server 129 via VSM interface 132, and (3) the VGTE 126 via access/channel feedback interface 135.

The VSM Engine 119 may be configured to perform various other related functions. For example, the VSM Engine 119 may be configured to report various types of information to WSP network 120, such as one or more of status information associated with the mobile device 110 (e.g., CPU information, battery level, air link quality, or the like), status information associated with a particular video client 111 (e.g., session start information, session parameters, client capabilities, video screen size information, or the like), route and dynamic video quality information, or the like, as well as various combinations thereof. For example, the VSM Engine 119 may be configured to provide additional smoothing/buffering below the TCP/IP layer for uplink and/or downlink mobile live video session streams of mobile device 110. For example, the VSM Engine 119 may be configured to provide one or more of video flow control and access mapping, intra-technology handoff optimization, video flow management on inter-access handoffs, WiFi offload functions, or the like, as well as various combinations thereof.

In a third embodiment, the VSM Engine 119 is configured to enable WSP management of (and, in some cases, control over) HAS video sessions, thereby enabling smoother user experiences during HAS video sessions.

In at least some embodiments, VSM capabilities allow for HAS client controls for WSP policies.

In at least some embodiments, one or more APIs may be supported between the VCE 119_{C} and a HAS video client 111 for enabling HAS video client 111 to obtain additional input information which may be utilized by the HAS video client 111 when running its Rate Determination Algorithm(s), thereby enabling improved user QoE for a user of the HAS video client 111.

In at least some embodiments, controls are provided via VSM processes in which WSP RAN policy/scheduling decisions, interfaces, and/or protocols are combined with available local client knowledge.

In at least some embodiments, VSM capabilities allow for improved HAS Rate Determination Algorithms (RDAs) of HAS clients with cooperative scheduling across multiple HAS clients within the same cell and/or across cells. In at least some such embodiments, VSM capabilities enable cooperation between the HAS RDAs of HAS clients and an associated scheduler on the associated wireless access node (e.g., eNodeB 122 in FIG. 1).

In at least some embodiments, VSM capabilities enable cooperation across multiple HAS clients sharing the same over-the-air link (e.g., smooth and fair quality distribution across clients served by the same cell) and the same RAN (e.g., smooth user experience when moving across cells within the same RAN) under control of the VSM server 129. In at least some embodiments, VSM capabilities enable smoother, more predictable, higher-quality video QoE (e.g., optimal dynamically adjustable HAS client buffer size and fullness thresholds, new HAS algorithm modes (e.g., dynamically changing algorithm parameter thresholds), the aggressiveness of buffer fill, or the like).

In at least some embodiments, VSM capabilities support introduction of new inputs into HAS RDAs. In at least some embodiments, for example, dynamic video buffer size configuration is supported. In one such embodiment, for example, when channel conditions are relatively good and extra bandwidth is available but relatively bad conditions are expected soon after, instead of increasing the video resolution it is better to increase the video buffer size and pre-load an extra portion of the video so that when conditions become worse the extra pre-loaded video would prevent any problems that otherwise would have been experienced when conditions become worse. In at least some embodiments, for example, dynamic algorithm threshold configuration is supported. In one such embodiment, for example, based upon exact knowledge of network conditions and WSP policy, VSM Engine 119 can provide, to the HAS video client 111, RDA with optimal thresholds for buffer (e.g., low/high) and/or bandwidth (e.g., low/high) that trigger bitrate resolution changes where, in at least some cases, “optimal” may mean those that ensure video resolution change based upon WSP controls and smoothness of user QoE.

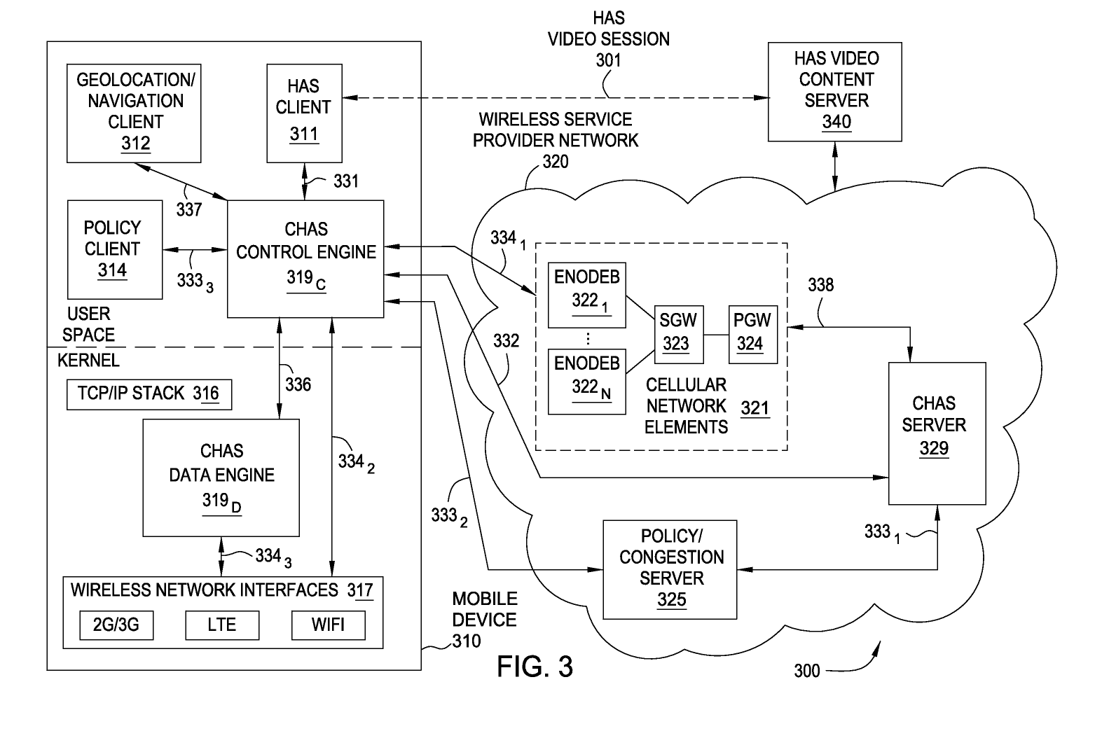

An exemplary embodiment configured to support WSP management of (and, in some cases, control over) HAS video sessions is depicted and described with respect to FIG. 3-FIG. 5.

In a fourth embodiment, VSM Engine 119 is configured to enable functions to be performed below the TCP stack level for non-cooperating video clients 111. The functions may include traffic smoothing, traffic shaping, or the like, as well as various combinations thereof. The non-cooperating video clients 111 may include video clients 111 that are VSM unaware, video clients 111 that are hostile (e.g., attempting to overload WSP network 120), or the like. In at least some embodiments, the non-cooperating video clients 111 may be non-cooperating HAS clients. In at least some embodiments, enforcement for non-cooperating video clients 111 may be provided by VDE 119_{D} via a combination of two functions: (1) buffering of downlink traffic (e.g., (identified via deep packet inspection or in any other suitable manner) below the TCP layer in order to force the RDA bandwidth estimation (e.g., based upon roundtrip delay between sending of the video chunk request by the mobile device 110 and receiving the downloaded video chunk at the mobile device 110) to be in compliance with the bandwidth that WSP wants to allocate for this mobile device 110 and (2) delaying TCP requests (e.g., identified via deep packet inspection or in any other suitable manner) in the uplink direction for new video chunks.

It will be appreciated that, whereas the second embodiment describes the manner in which better video QoE can be provided for the user while using WSP-enforced video bitrates, the third embodiment describes the manner in which the video bitrate policy of the WSP can be enforced for VSM-unaware video clients.

In a fifth embodiment, the VSM Engine 119 is configured to support yield management. In at least some embodiments, yield management may be provided using an interface between VSM server 129 and a yield management server in the WSP network, which enables the WSP to monetize video delivery and to influence HAS policy by using network congestion and mobile device status information to impose bandwidth restrictions. The use of the VSM capabilities in combination with yield management overcomes various shortcomings of various existing yield management schemes (e.g., failure to support live video calls, video conferencing, and interactive gaming, failure to support proactive management, failure to handle greedy client behavior resulting in uneven bandwidth distribution across similar clients, or the like). The VSM-based management provides smooth user QoE and enforces explicit WSP control over video session bitrates (including HAS video session bitrates).

In a sixth embodiment, VCE 119_{C} may provide information to a video session scheduler of eNodeB 122 for use by the video session scheduler to schedule the video session of the mobile device 120. For example, the information provided to the video session scheduler may include available video bitrates from a manifest of video bitrates (e.g., obtained from the video client 111, snooped, and/or obtained in any other suitable manner), information indicative of device parameters of the mobile device 120 (e.g., screen size used for video display, battery status, CPU occupancy, or the like), or the like, as well as various combinations thereof. In at least some embodiments, coordinated scheduling of video sessions across multiple eNodeBs 122 may be supported.

In a seventh embodiment, VSM Engine 119 is configured to provide improvements in video transcoding. In at least some embodiments, VSM Engine 119 is configured to provide information from the mobile device 110 to VGTE 126 via access/channel feedback interface 135, for use by VGTE 126 in improving video transcoding for video sessions to mobile device 110.

In an eighth embodiment, VSM Engine 119 is configured to provide smoothing for secure encrypted video sessions (e.g., secure encrypted HAS video sessions, live video sessions, or the like). In at least some embodiments, a secure encrypted video session is established between a video client 111 and the video content element 140. It will be appreciated that the video content element 140 may be behind a firewall (e.g., a third-party corporate firewall) without any interface to WSP policy servers. It is further noted that any video delivery and control capabilities that depend on deep packet inspection in the WSP radio access network would not work due to the encrypted nature of the video traffic. In embodiments employing VSM capabilities, on the other hand, smooth mobile video quality may be provided even for secure encrypted video sessions. In at least some embodiments, VCE 119_{C} obtains video session parameter information (e.g., information about video session parameters necessary for establishing a smooth video session) from one of the video clients 111 via the video client interface 131, provides the video session parameter information to the WSP network 120, receives video session management information from the WSP network 120, and provides the video session management information to the video client 111. It will be appreciated that any of the foregoing seven embodiments depicted and described with respect to FIG. 1 may be used in conjunction with this eighth embodiment related to secure encrypted video sessions.

In a ninth embodiment, VSM Engine 119 is configured to support real-time video servers with data sensor overlay. This may enable various types of services to be supported, such as medical emergency services (e.g., supporting data overlay of vital health statistics of the patient), first responder services (e.g., data overlay of environment monitoring), military-related services (e.g., data overlay of operative information), or the like. In at least some embodiments, transmission of data overlay information may be prioritized over transmission of video/audio content. In at least some embodiments, the best-available video may be provided at the expense of lower video consistency. In at least some embodiments, video/data delivery management and/or control policies/priorities may be controlled by the mobile device 110 (e.g., for a medical emergency team transporting a patient). The VSM Engine 119 may be configured to enable these and other services, providing one or more of uplink and/or downlink flow management for the data overlay and video/audio content, providing SLA and QoS management and flow mapping, providing a balance of policy control between WSP network 120 and mobile device 110, supporting the proper choice of video quality (e.g., best rate available or consistent), or the like, as well as various combinations thereof.

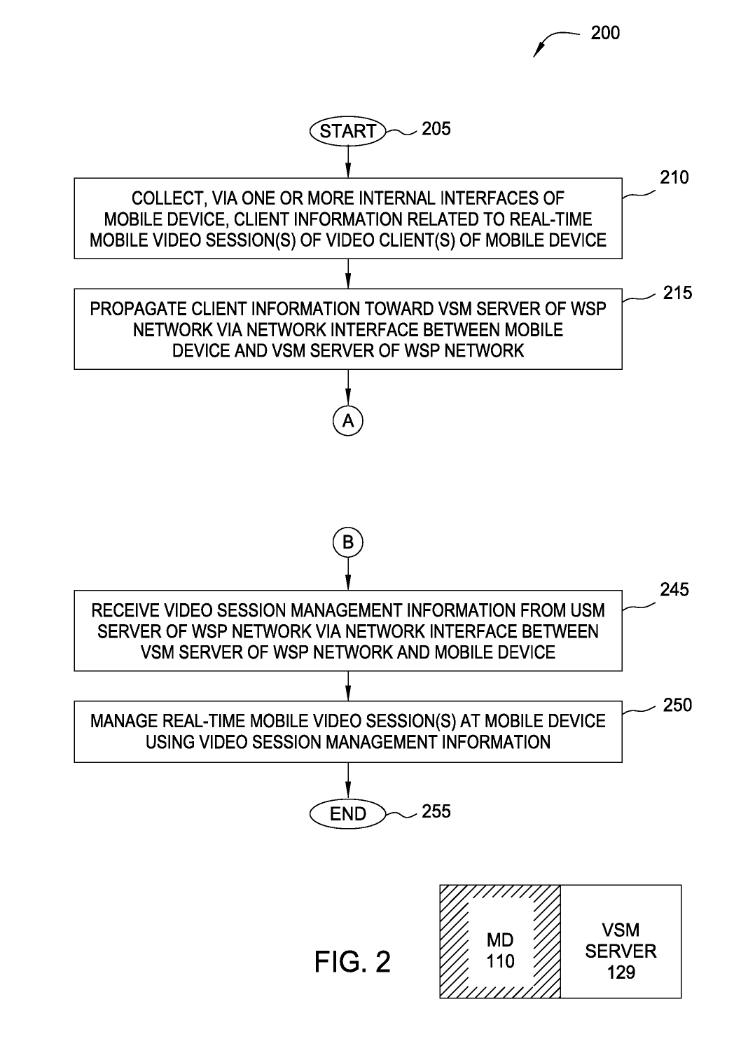

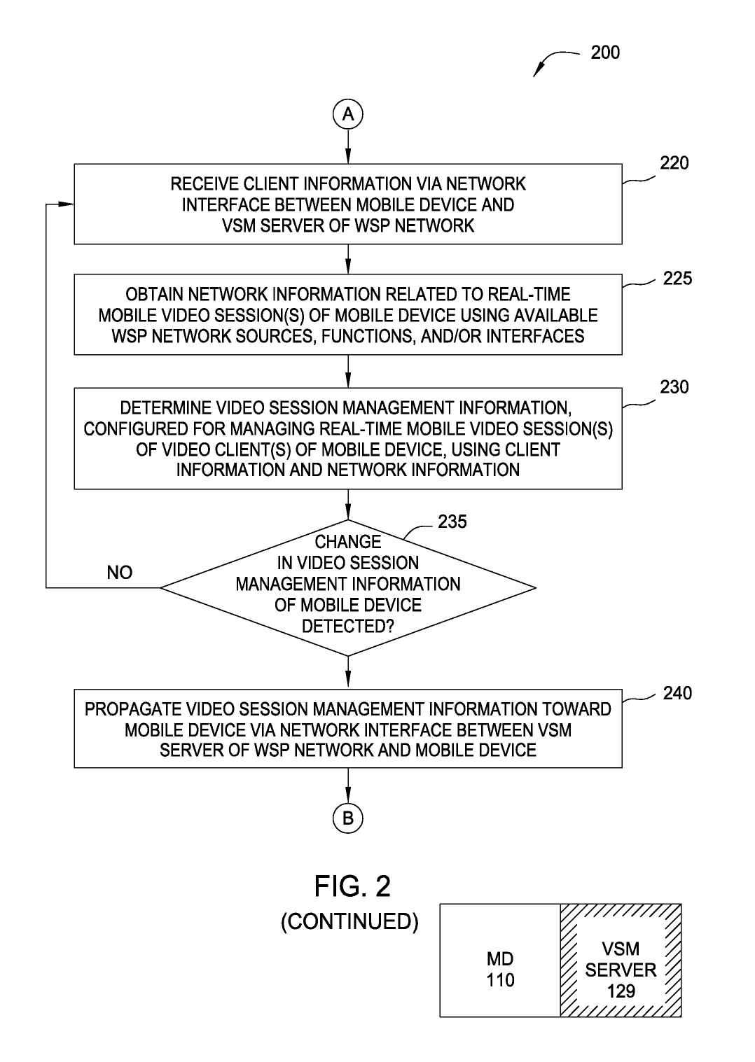

It will be appreciated that although the various embodiments which may be supported by system 100 are primarily depicted and described independently, any suitable combination(s) of such embodiments may be used within system 100. An exemplary method for support at least some such embodiments is depicted and described with respect to FIG. 2.

FIG. 2 depicts one embodiment of a method for managing/controlling real-time mobile video sessions on a mobile device using interaction between the mobile device and a WSP network.

As indicated by the legend on FIG. 2, a portion of the steps of method 200 are performed by a mobile device (illustratively, steps 210, 215, 245, and 250 being performed by mobile device 110) and a portion of the steps of method 200 are performed by a video session management server in a WSP network (illustratively, steps 220, 225, 230, 235, and 240 being performed by VSM server 129 of FIG. 1).

At step 205, method 200 begins.

At step 210, the mobile device collects client information related to a real-time mobile video session(s) of a video client(s) of the mobile device. The client information may be collected by a video session management engine on the mobile device (e.g., the VSM Engine 119 of mobile device 110 of FIG. 1). The client information may be collected from one or more components, elements, and/or agents of the mobile device via one or more internal interfaces of the mobile device (e.g., from one or more video clients 111 via one or more video client interfaces 131, from a geolocation/navigation client 112 via geolocation/navigation interface 137, from policy client 114 via third user/session policy interface 133₃, from the WNIs 117 via second local RRC and wireless modem status and channel conditions interface 134₂, from VDE 119_{D} via throughput/channel status interface 136, or the like, as well as various combinations thereof). The types of client information that may be collected are described in detail in conjunction with the various embodiments described hereinabove with respect to FIG. 1.

At step 215, the mobile device propagates the client information toward the video session management server of the WSP network via a network interface between the mobile device and the video session management server.

At step 220, the video session management server receives the client information via the network interface between the video session management server and the mobile device. For example, the client information may be propagated from the video session management engine on the mobile device to the video session management server of the WSP network (e.g., from the VSM Engine 119 of mobile device 110 to the VSM Server 129 of WSP network 120 via VSM interface 132, as depicted in FIG. 1).

At step 225, the video session management server obtains network information related to a real-time mobile video session(s) of a video client(s) of the mobile device. The network information may be obtained from one or more elements of the WSP network via one or more network interfaces of the WSP network (e.g., using available WSP network functions, sources, and/or interfaces). For example, the network information may be obtained from policy congestion server 125 via first user/session policy interface 133₁, from one or more of the cellular network elements 121 via cooperative mobile devices connection/throughput status and scheduling control interface 138, from VGTE 126 via gateway/transcoding control interface 139, or the like, as well as various combinations thereof. The network information may be obtained using at least a portion of the client information. The types of network information that may be obtained are described in detail in conjunction with the various embodiments described hereinabove with respect to FIG. 1.

At step 230, the video session management server determines video session management information using the client information and the network information. The video session management information is configured for use by the mobile device to manage the real-time mobile video session(s) at mobile device.

For example, the video session management information for a real-time mobile video session may include a bitrate for the real-time mobile video session. The bitrate may be a recommended bitrate or a bitrate that the mobile device is required to use. In the case of real-time mobile video session for a live video call, the bitrate may be a bitrate for the uplink from the mobile device toward the WSP network (e.g., the bitrate for encoding of video content to be provided from the mobile device during the live video call). In the case of real-time mobile video session that is a HAS video session, the bitrate may be a bitrate for the downlink from the video content source toward the mobile device via the WSP network (e.g., the bitrate of video content to be requested by the mobile device for the HAS video session).

For example, the video session management information for a real-time mobile video session may include one or more video session parameters for the real-time mobile video session. The video session parameters may be parameters to be used for the real-time mobile video session. The video session parameters may be parameters for use by a video client of the mobile device to modify an associated rate determination algorithm of the video client (e.g., to produce better and more consistent bitrate selection under the current wireless network conditions). The video session parameters may include any other suitable types of parameters.

At step 235, a determination is made as to whether a change is detected in the video session management information for the mobile device.

It will be appreciated that a change in the video session management information for the mobile device may result from a change of conditions associated with the mobile device (e.g., conditions on the mobile device, network conditions for the mobile device, or the like), a change in conditions associated with one or more other mobile devices (e.g., another mobile device joined or dropped such that the bandwidth available to the mobile device changes), a change in network conditions independent of any mobile devices, or the like, as well as various combinations thereof.

If a change in the video session management information for the mobile device is not detected, method 200 returns to step 220. This indicates that the video session management server continues to receive and analyze client information and network information for determining whether the video session management information for the mobile device has changed. It will be appreciated that the video session management server may not receive client information and network information for each execution of this loop (e.g., sometimes only client information may be received and other times only network information may be received).

If a change in the video session management information for the mobile device is detected, method 200 proceeds to step 240. It will be appreciated that, although omitted for purposes of clarity, the video session management server also continues to receive and analyze client information and network information for determining whether the video session management information for the mobile device has changed (i.e., steps 220-235 of method 200 continue to be performed for determining whether a subsequent change in the video session management information of the mobile device is detected).

At step 240, the video session management server propagates the newly calculated video session management information toward the mobile device via one or more network interfaces between the WSP network and the mobile device. At step 245, the mobile device receives the video session management information from the video session management server. For example, the video session management information may be propagated from the video session management server of the WSP network to the video session management engine on the mobile device (e.g., from VSM Server 129 of WSP network 120 to the VSM Engine 119 of mobile device 110 via VSM interface 132, as depicted in FIG. 1).

At step 250, the mobile device manages the real-time mobile video session(s) of the mobile device using the video session management information. The management of the real-time mobile video session may include one or more of informing a video client(s) of the mobile device of a bitrate to be used for a real-time mobile video session(s), communicating to a video client(s) of the mobile device of one or more video session parameters to be used for a real-time mobile video session(s), interacting with one or more elements of the WSP network to control scheduling of packets of a real-time mobile video session(s), or the like, as well as various combinations thereof. It will be appreciated that other management functions which may be performed by the mobile device using the video session management information are described in the various embodiments described hereinabove with respect to FIG. 1.

At step 255, method 200 ends.

It will be appreciated that, although primarily depicted and described as ending (for purposes of clarity), method 200 may be repeated for determining whether new video session management information is to be propagated from the video session management server to the mobile device (e.g., the video session management server continues to receive event-driven and/or polled client and/or network information and to analyze the received information to determined whether the video session management information of the mobile device has changed).

It will be appreciated that, although primarily depicted and described herein as being performed serially, various steps of method 200 may be performed contemporaneously and/or in a different order than depicted in FIG. 2. For example, steps 210 and 215 may be performed in parallel or step 215 may be performed before step 210. For example, steps 220 and 225 may be performed in parallel or step 225 may be performed before step 220. For example, steps 245 and 250 may be performed in parallel or step 250 may be performed before step 245. It is noted that other variations are contemplated.

It will be appreciated that, although primarily depicted and described from the perspective of a single mobile device, method 200 may be performed for multiple mobile devices. For example, the video session management server may receive client information from clients of mobile devices and received network information associated with the network supporting the mobile devices and determine, for each of the mobile devices, whether the video session management information has changed such that new video session management information is to be propagated from the video session management server to the mobile device.

In at least some embodiments, an apparatus includes a processor and a memory communicatively connected to the processor. The processor is configured to collect, at a video control engine of a mobile device, client information associated with a real-time mobile video session of a video client of the mobile device. The processor is configured to propagate the client information toward one or more elements of a wireless service provider (WSP) network via one or more interfaces between the mobile device and the one or more elements of the WSP network. The processor is configured to receive, at the mobile device, video session management information determined by one or more elements of the WSP network using the client information and network information associated with the WSP network. The processor is configured to initiate management of the real-time mobile video session at the video control engine of the mobile device using the video session management information. The client information may include at least one of geolocation information, navigation information, signal quality information, mobile device occupancy information, mobile device battery level information, mobile device screen size information, or information shared by the video client. The information shared by the video client may include at least one of available video session bit rate encodings, video segment information for a Hypertext Transfer Protocol (HTTP) adaptive streaming session, at least one of security information and encryption keys information for a secure video session, or a video camera capability for a live video session. The network information may include at least one of service cell load information, mobile location information, mobile movement information, cell congestion information, network congestion information, or wireless mobile conditions of mobile devices. The video session management information may include at least one of a bitrate to be used for the real-time mobile video session, at least one video session parameter to be used for the real-time mobile video session, or information configured for use by the video client of the mobile device to modify an associated rate determination algorithm (RDA). The real-time mobile video session may be a live video session, and the video session management information may include an encoding bitrate for use by the video client in encoding video for upstream transmission toward the WSP network. The real-time mobile video session may be a Hypertext Transfer Protocol (HTTP) Adaptive Streaming (HAS) video session, and the video session management information may include a bitrate recommended for use by the video client in requesting video segments from a HAS video content server. Managing the real-time mobile video session of the video client of the mobile device using the video session management information may include at least one of informing the video client of the mobile device of a bitrate to be used for the real-time mobile video session, informing the video client of the mobile device of at least one video session parameter to be used for the real-time mobile video session, or initiating interaction by the mobile device with one or more elements of the WSP network for controlling scheduling of packets of the real-time mobile video session. The real-time mobile video session may be a live video session, the video session management information received at the mobile device may be in a first format adapted for use in the WSP network, and the processor may be configured to convert the video session management information received at the mobile device in the first format to video session management information in a second format adapted for use by the video client of the mobile device to provide uplink video toward the WSP network with a controlled bitrate. The real-time mobile video session may be a live video session with Scalable Video Coding (SVC) including a plurality of video layers, and the processor may be configured to propagate at least a portion of the client information toward a video gateway configured to filter the video layers of the live video session for use by the video gateway in filtering the video layers of the live video session. The video client may be a Hypertext Transfer Protocol (HTTP) Adaptive Streaming (HAS) client, and the processor may be configured to support video session quality enforcement for the HAS client when the HAS client is uncooperative in terms of a video bitrate policy of the WSP network or unaware of a video session management control capability in the WSP network. The processor may be configured to perform at least one of controlling buffering of downlink traffic of the real-time mobile video session below the Transmission Control Protocol (TCP) layer for thereby forcing a Rate Determination Algorithm (RDA) bandwidth estimation to be in compliance with an amount of bandwidth allocated by the WSP for the real-time mobile video session and controlling delaying of TCP requests for new video segments propagated in an upstream direction from the mobile device toward the WSP network. In at least some embodiments, the apparatus may be the mobile device itself. In at least some embodiments, the apparatus may be configured to form part of the mobile device. In at least some embodiments, a computer-readable storage medium may be configured to store instructions which, when executed by a computer, cause the computer to perform one or more corresponding methods which may be configured to provide various features discussed above in conjunction with the apparatus. In at least some embodiments, one or more corresponding methods may be configured to provide various features discussed above in conjunction with the apparatus.

As described hereinabove, at least some embodiments system 100 of FIG. 1 and method 200 of FIG. 2 may be configured to provide a cooperating HAS capability configured to support cooperating HAS video sessions over a cellular network. This embodiment is depicted and described in additional detail with respect to FIGS. 3-5.

FIG. 3 depicts a high-level block diagram of a system configured to manage cooperating HAS video sessions over a cellular network.

As depicted in FIG. 3, system 300 includes a mobile device 310, a wireless service provider (WSP) network 320, and a HAS video content server 340.

The system 300 is configured to support delivery of video content from HAS video content server 340 to mobile device 310 via WSP network 320.

The mobile device 310 may be any suitable type of device configured to communicate via one or more types of wireless networks, e.g., one or more types of cellular network (e.g., 2G cellular networks, 3G cellular networks, LTE 4G cellular networks, or the like), WiFi networks, or the like. For example, mobile device 310 may be a cellular phone, a smartphone, a tablet computer, a laptop computer, or the like.

It will be appreciated that mobile device 310 of FIG. 3 may be identical to or similar to mobile device 110. For example, the mobile device 310 may be implemented such that it is identical, or at least substantially similar, to mobile device 110 of FIG. 1 (e.g., mobile device 310 also may include support for live video sessions) even though FIG. 3 is primarily focused on the HAS-related capabilities of the mobile device. For example, the mobile device 310 may be implemented as depicted and described with respect to FIG. 3 (e.g., where mobile device 310 does not include support for live video sessions). In any event, it will be appreciated that, in various embodiments, various functions of mobile device 110 of FIG. 1 also may be supported by mobile device 310 the FIG. 3 and, similarly, various functions of mobile device 310 of FIG. 3 also may be supported by mobile device 110 of FIG. 1.

The mobile device 310 software/firmware includes a user space and a kernel, each of which includes various components, elements, and/or engines supporting various capabilities of the mobile device 310. More specifically, the mobile device 310 includes a HAS client 311, a geolocation/navigation client 312, a policy client 314, a TCP/IP stack 316, a plurality of wireless network interfaces (WNIs) 317, and a Cooperating HAS (CHAS) Engine 319 composed of a CHAS Control Engine (CCE) 319_{C} and a CHAS Data Engine (CDE) 319.

The HAS client 311, geolocation/navigation client 312, policy client 314, and CCE 319_{C} may be associated with the user space of mobile device 310. The HAS client 311 is configured to support real-time mobile HAS video sessions (e.g., for live streaming of movies and other video content). The geolocation/navigation client 312 may be any type of client configured to support geolocation and, optionally, navigation functions on the mobile device 310. The policy client 314 is configured to obtain and/or store policy information, at least a portion of which may be obtained from one or more elements of WSP network 320 (e.g., policy server 325). The CCE 319_{C} is configured to support management and control of real-time mobile HAS video sessions of HAS client 311.

The TCP/IP stack 316, WNIs 317, and CDE 319_{D} may be associated with the kernel of mobile device 310. The typical operation of TCP/IP stack 316 and WNIs 317 will be understood. Although depicted as including specific numbers/types of WNIs 317 (including cellular WNIs and a WiFi WNI), it will be appreciated that the mobile device 310 may include fewer or more WNIs and/or one or more other types of WNIs. The CDE 319_{D} is configured to support management and control of real-time mobile HAS video sessions of HAS client 311.

It will be appreciated that the various components, elements, and/or engines may be disposed across the user space and kernel of the mobile device 310 in any other suitable manner and/or may be arranged using any other suitable organization of spaces and/or other portions of the mobile device 310.

It will be appreciated that, although depicted and described with respect to an exemplary mobile device 310 having a specific type of architecture (e.g., including an operating system configured to include a user space and a kernel, each having specific modules/engines), the architecture of the mobile device 310 may be designed in any other suitable manner (e.g., using any other suitable type of operating system architecture). For example, the distribution of the various modules/engines across the user space and the kernel may be different. For example, the mobile device 310 may be configured such that it does not include a user space. Other arrangements are contemplated.

It will be appreciated that, although depicted and described with respect to an exemplary mobile device 310 having a specific combination of client modules, mobile device 310 may include fewer or more (as well as different) client modules. For example, the client device 310 may include multiple HAS clients and/or one or more other types of video clients. For example, the client device 310 may exclude geolocation/navigation client 312 and/or policy client 314. Other sets of clients are contemplated.

It will be appreciated that mobile device 310 may include various other components, elements, and/or engines supporting other types of functions typically performed by mobile devices, at least a portion of which also may be utilized for providing various functions of the cooperating HAS capability.

The WSP network 320 may be any suitable type of wireless network, e.g., a cellular network (e.g., a 2G cellular network, a 3G cellular network, an LTE 4G network, or the like), a WiFi network, or the like. In the exemplary embodiment of FIG. 3, the WSP network 320 is depicted as an LTE cellular network (although various embodiments depicted and described herein are applicable to other types of networks, such as other types of cellular networks (e.g., 2G cellular networks, 3G cellular networks, beyond 4G cellular networks, or the like), WiFi networks, or the like).

The WSP network 320 includes cellular network elements 321 configured to support control and bearer sessions for WSP network 320, a policy/congestion server 325, a HAS video content server 340, and a CHAS server 329. The cellular network elements 321, given that in this example WSP network 320 is implemented as an LTE cellular network, include a plurality of eNodeBs 322₁-322_{N} (collectively, eNodeBs 322), a Serving Gateway (SGW) 323, and a Packet Data Network (PDN) Gateway PGW 324. Similarly, the policy/congestion server 325 may be implemented as/using a 3GPP ANDSF function or any other suitable policy functions. The CHAS server 329 interfaces with CHAS Engine 319 of mobile device 310 to provide various functions of the CHAS capability and, in some embodiments, may support cooperation of multiple HAS clients of multiple mobile devices.

The system 300 includes a number of interfaces in support of the CHAS capability, some of which are internal to mobile device 310, some of which are internal to WSP network 320, and some of which are established between mobile device 310 and WSP network 320. The interfaces include a HAS client interface 331 between HAS client 311 and CCE 319_{C}, a cooperative HAS video session management and control interface 332 between CCE 319_{C} and CHAS server 329, a set of status feedback interfaces 333 (including a first user/session policy interface 333₁ between policy/congestion server 325 and CHAS server 329, a second user/session policy interface 333₂ between policy/congestion server 325 and CCE 319_{C}, and, optionally, a third user/session policy interface 333₃ between CCE 319_{C} and policy client 314), a set of RRC interfaces 334 (illustratively, a network RRC interface 334₁ between CCE 319_{C} and cellular network elements 321, a first local RRC and wireless modem status and channel conditions interface 334₂ between CCE 119_{C} and WNIs 317, and a second local RRC and wireless modem status and channel conditions interface 334₃ between CDE 319_{D} and WNIs 317), a throughput/channel status interface 336 between CCE 319_{C} and CDE 319_{D}, a geolocation/navigation interface 337 between CCE 319_{C} and geolocation/navigation client 312, and a cooperative mobile devices connection/throughput status and scheduling control interface 338 between CHAS server 329 and one or more of the cellular network elements 321.

The HAS video content server 340 is a source of HAS video content which may be delivered to mobile device 310 (illustratively, for HAS client 311 of mobile device 310) via WSP network 320. It will be appreciated that HAS video content server 340 may include multiple elements and functions, which could be collocated or distributed across different network entities. It is further noted that HAS video content server 340 is expected to support typical HAS server functions. As depicted in FIG. 3, HAS video content server 340 may be located outside of WSP network 320 and accessible via any suitable communication network(s) (e.g., via the Internet). Although primarily depicted and described herein with respect to an embodiment in which the HAS video content server 340 is located outside of WSP network 320, it will be appreciated that the HAS video content server 340 also could be located within WSP network 320 or in any other suitable location accessible to WSP network 320. Although primarily depicted and described herein with respect to a single HAS video content server 340, it will be appreciated that multiple HAS video content servers may be available for providing HAS video content to mobile device 310 as well as to other mobile devices served by WSP network 320.

The HAS video content is delivered via a HAS video session 301 between the mobile device 310 (illustratively, HAS client 311 of mobile device 310) and the HAS video content server 340. Although omitted for purposes of clarity, it will be appreciated that, within mobile device 310, the HAS video session 301 may traverse a path typically traversed by video sessions in mobile devices. For example, in a downlink direction from WSP network 320 toward mobile device 310, the HAS video session 301 may traverse a path from the WNIs 317 to TCP/IP stack 316 and from TCP/IP stack 316 to HAS video client 311. It is understood that this path may include various other elements and/or functions typically used to support HAS video sessions in mobile devices (e.g., various other layers of the communications stack or the like). In at least some embodiments, as depicted in FIG. 3, the HAS video session 301 also may include CDE 319_{D} disposed between TCP/IP stack 316 and WNIs 317. The CDE 319_{D} may be omitted from mobile device 310, or may be included within mobile device 310 such that it is transparent to the HAS video session 301 except when providing one or more functions as depicted and described herein (e.g., taking measurements regarding the level of quality of the HAS video session 301, performing buffering of packets below the TCP layer for HAS video session 301, or the like).

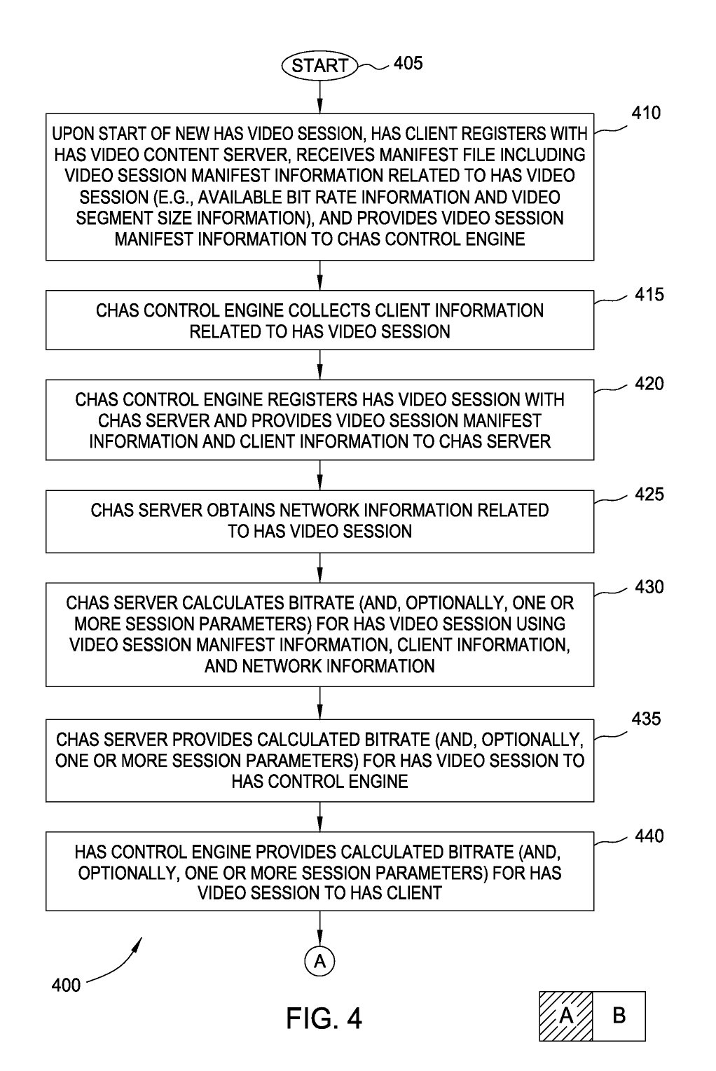

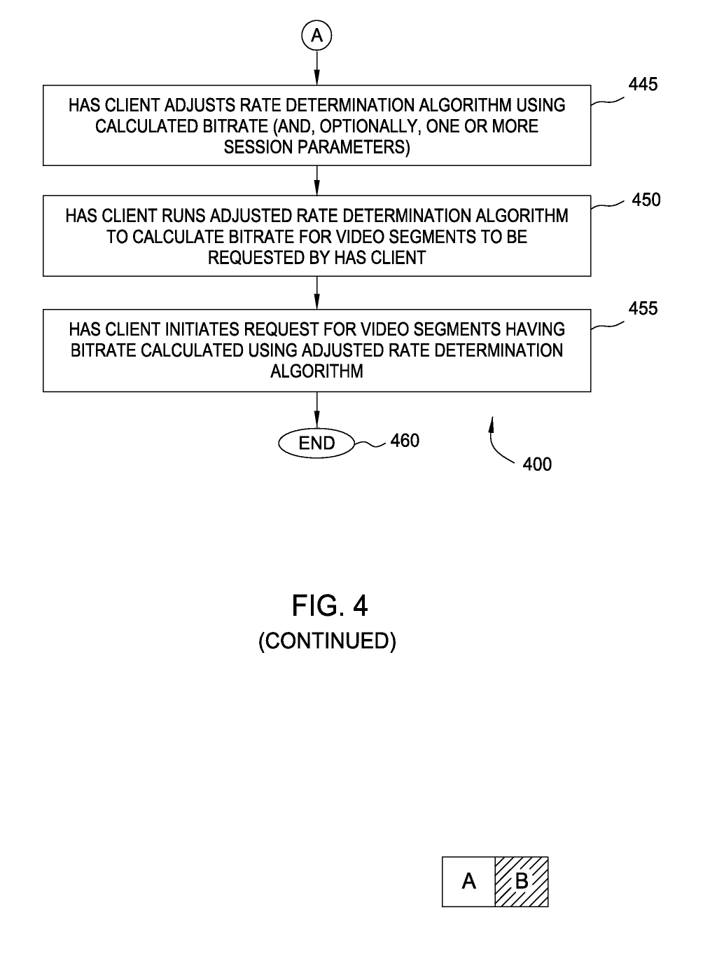

FIG. 4 depicts one embodiment of a method for providing cooperative video bitrate and session parameter selection for a HAS video session. Although primarily depicted and described as being performed serially, it will be appreciated that at least a portion of the steps of method 400 may be performed contemporaneously and/or in a different order than depicted and described with respect to FIG. 4.

At step 405, method 400 begins.

At step 410, upon start of a new HAS video session, HAS client 311 of mobile device 310 registers with HAS video content server 340, receives a manifest file (which also may be referred to as a playlist file) including video session manifest information (e.g., available bitrate information, video segment size information, or the like), and provides the relevant video session manifest information to CCE 319_{C} via HAS client interface 331.

At step 415, the CCE 319_{C} collects additional information related to the HAS video session. For example, CCE 319_{C} may collect video session information related to the capability of mobile device 310 to support the HAS video session (e.g., screen size—native (small for smartphones, bigger for tablets and laptops) or attached High Definition external TV), device CPU occupancy, device battery level, or the like, as well as various combinations thereof). For example, CCE 319_{C} may collect one or more of channel condition information, signal quality information, and service cell information via the throughput/channel status interface 336. For example, the CCE 319_{C} may collect geolocation/navigation information via geolocation/navigation interface 337. For example, the CCE 319_{C} may collect policy information via third user/session policy interface 333₃. It will be appreciated that CCE 319_{C} may collect various combinations of such information.

At step 420, CCE 319_{C} registers a CHAS video session with CHAS server 329 and provides the obtained information (e.g., the information received in step 410 and the information collected in step 415) to CHAS server 329 via cooperative HAS video session management and control interface 332.

At step 425, CHAS server 329 obtains network information associated with HAS video sessions active in the WSP network 320.

The CHAS server 329 collects network information related to HAS video sessions active in the WSP network 320. This network information may be collected by the CHAS server 329 in any suitable manner (e.g., continuously, periodically, in response to events or conditions, or the like). The collection of such network information ensures that the network information is available for use by the CHAS server 329 for performing bitrate calculations (e.g., such as when a new CHAS video session is registered as described in steps 420 and 425).

The CHAS server 329 may obtain the network information related to HAS video sessions active in the WSP network 320 from any suitable source. For example, CHAS server 329 may obtain the network information from one or more local and/or remote memories/databases in which the network information may be stored and maintained as it is collected by CHAS server 329.

The network information may include various types of information related to support of HAS video sessions in WSP network 320. For example, CHAS server 329 may obtain, from one or more of the cellular network elements 321 via bandwidth and mobile link status interface 338, information about the data bandwidth available for the CHAS video session and, optionally, any associated signal quality information. For example, the data bandwidth availability and signal quality information may be obtained from one or more of an eNodeB 322 currently serving the mobile device 310 (and an identified future serving eNodeB(s) 322 which may serve the mobile device 310 in the future, e.g., if mobility prediction information is available), the PGW 324 currently serving the mobile device 110, or the like, as well as various combinations thereof. For example, CHAS server 329 may obtain, from policy/congestion server 325 via first user/session policy interface 333₁, policy information (e.g. user subscription level Gold-Silver-Bronze, or video content related service level agreement with the video content provider) and/or serving cell congestion information relevant to the CHAS video session. For example, CHAS server 329 also receives similar types of information for a set of HAS video sessions associated with WSP network 320 (e.g., some or all of the HAS video sessions for some or all of the mobile devices served by the RAN currently serving the mobile device 310).

At step 430, CHAS server 329 uses the obtained information to calculate a recommended bitrate for the CHAS video session and, optionally, one or more CHAS video session parameters for the CHAS video session (e.g., one or more bitrate selection algorithm thresholds or parameters, recommended cache buffer size for smoothing QoE for the end user, or the like, as well as various combinations thereof). The CHAS server 329 also may recalculate the recommended bitrate(s) of one or more existing HAS video sessions for one or more reasons and/or under one or more conditions (e.g., to make room for the newly added CHAS video session, in case the serving network becomes congested, in case more bandwidth becomes available, in case signal quality for the given mobile device(s) changes due to mobility event, and/or for any other suitable purpose/condition).

At step 435, CHAS server 329 provides the calculated bitrate (and, when calculated, other relevant HAS video session parameters discussed above) to CCE 319_{C} via cooperative HAS video session management and control interface 332.

At step 440, CCE 319_{C} provides the calculated bitrate (and, when calculated, other relevant HAS video session parameters discussed above) to HAS client 311 via HAS client interface 331. In at least some embodiments, CCE 319_{C} may perform translation of some or all of the received parameters (e.g., from parameters defined in a manner recognized or accepted by network elements to parameters recognized or accepted by the HAS client 311) and provide the translated parameter(s) to HAS client 311 via HAS client interface 331.

At step 445, HAS client 311 adjusts its Rate Determination Algorithm using the calculated bitrate and, when calculated, other HAS video session parameters.

At step 450, HAS client 311 runs its adjusted Rate Determination Algorithm to calculate a bitrate for video segments to be requested by HAS client 311. This allows or forces HAS client 311 to lower the bitrate if suggested or required by the adjusted RDA. In this manner, the WSP is able to control the RDA executed on HAS client 311 in a manner that enables the WSP to control the bitrate of the video segments ultimately requested by HAS client 311.

In steps 430-450, the HAS video session parameters may include various types of parameters which may be specified by the WSP to influence or control calculation of bitrates by the HAS client 311 using its Rate Determination Algorithm.

For example, a HAS video session parameter may indicate a weight or importance to be assigned to the recommended bitrate calculated by the CHAS server 329 and provided to the HAS client 311. For example, a HAS video session parameter may indicate that the bitrate calculated by the CHAS server 329 is the maximum bitrate that can be requested by HAS client 311, thereby providing WSP-controlled capping of the bitrate which may be requested by HAS client 311 via execution of its Rate Determination Algorithm. For example, a HAS video session parameter may indicate that the bitrate calculated by the CHAS server 329 is only a recommendation and, thus, that the HAS client 311 is not required to follow it or even consider it when executing its adjusted RDA.

For example, a HAS video session parameter(s) may indicate one or more weights to be assigned to one or more parameters of the RDA of the HAS client 311, thereby controlling adjustment of the RDA of the HAS client 311 and, thus, enabling the WSP to control the manner in which the RDA of HAS client 311 computes a bitrate for the HAS video session.

It will be appreciated that the HAS video session parameters may include any other types of parameters suitable for use in adjusting/controlling the RDA of HAS video client 311.

At step 455, HAS client 311 initiates, toward HAS video content server 340, a request, for video segments having the bitrate.

At step 460, method 400 ends.

It will be appreciated that, although depicted and described as ending for purposes of clarity, various functions may continue to be performed in conjunction with method 400 of FIG. 4.

It will be appreciated that, although primarily depicted and described herein with respect to an embodiment in which CHAS server 329 determines the calculated bitrate for HAS client 311 and provides the calculated bitrate to HAS client 311 in response to interaction between CHAS server 329 and CCE 319_{C}, CHAS server 329 may determine the calculated bitrate for HAS client 311 and provide the calculated bitrate for use by HAS client 311 in response to various other events and conditions. In this case, CHAS server 329 may determine the calculated bitrate for HAS client 311 and provide the calculated bitrate for use by HAS client 311 without any solicitation from HAS client 311. For example, such events or conditions may include a change to the calculated HAS policy for HAS client 311. For example, such events or conditions may include the start of a new HAS video session, termination of an existing HAS video session, or the like (where such starting/stopping of HAS video sessions may be performed by mobile device 310 and/or any other mobile device). For example, such events or conditions may include changes in cell and/or network congestion conditions (e.g., where continuous monitoring of the cell and/or network state by CHAS server 329 results in detection of an event or condition). For example, such events or conditions may include changes to WSP policies (e.g., peak hours versus non-peak hours), priority bandwidth allocation, or the like. It will be appreciated that unsolicited sending of the calculated bitrate by CHAS server 329 for use by HAS client 311 may be initiated by CHAS server 329 in various other situations.

It will be appreciated that, although primarily depicted and described herein as being performed serially, various steps of method 400 may be performed contemporaneously and/or in a different order than depicted in FIG. 4.

In at least some embodiments, for example, CHAS server 329 repeats steps 425-455 in response to a determination by CHAS server 329 that the bitrate for the HAS video session must/should be changed. For example, there are various conditions under which the CHAS server 329 can make gradual changes to the bitrate(s) of existing HAS video sessions in a manner for reducing (and possibly minimizing) the impact to the QoE of the associated end users. For example, such conditions may include when the bitrates for existing HAS video sessions need to be decreased to make room for the CHAS video session, when the bitrate(s) of one or more existing HAS video sessions may be increased due to termination of an existing HAS video session, or the like, as well as various combinations thereof.

In at least some embodiments, for example, CCE 319 continues to monitor the information obtained in step 415 for the duration of the CHAS video session and, if a condition (e.g., changes to one or more of the parameters by a threshold amount(s) or any other related condition) is detected, steps 420-440 of method 400 may be repeated (with the exception of the registration portion of step 420, which only needs to be performed at the start of the HAS video session).

In at least some embodiments, for example, rather than policy and/or congestion information being obtained by the CHAS server 329 via first user/session policy interface 333₁, policy and/or congestion information is obtained by the CCE 319_{C} via second user/session policy interface 333₂ (which may be performed with or without an intermediate policy client at mobile device 310) and provided from CCE 319_{C} to CHAS server 329. In one such embodiment, for example, CCE 319_{C} obtains policy and/or congestion information in conjunction with step 415 and conveys the policy and/or congestion information to CHAS server 329 in conjunction with step 420, and CHAS server 329 uses the policy and/or congestion information as part of step 430.

Although primarily depicted and described from the perspective of a single mobile device, it will be appreciated that method 400 may be performed for multiple mobile devices. For example, CHAS server 329 may receive client information from HAS clients of multiple mobile devices and network information associated with the network supporting the mobile devices and determine calculated bitrates for each of the HAS clients, respectively. For example, CHAS server 329 may continue to monitor the cell and/or network conditions for multiple HAS clients for purposes of determining whether to recalculate the bitrate(s) of one or more of the HAS clients (e.g., CHAS server 329 may repeat some or all of steps 425-455 for each mobile device having an active HAS video session).

It will be appreciated that, in at least some embodiments, method 400 of FIG. 4 may be considered to represent one or more specific implementations of an embodiment of method 200 of FIG. 2 for dynamic HAS video session control.

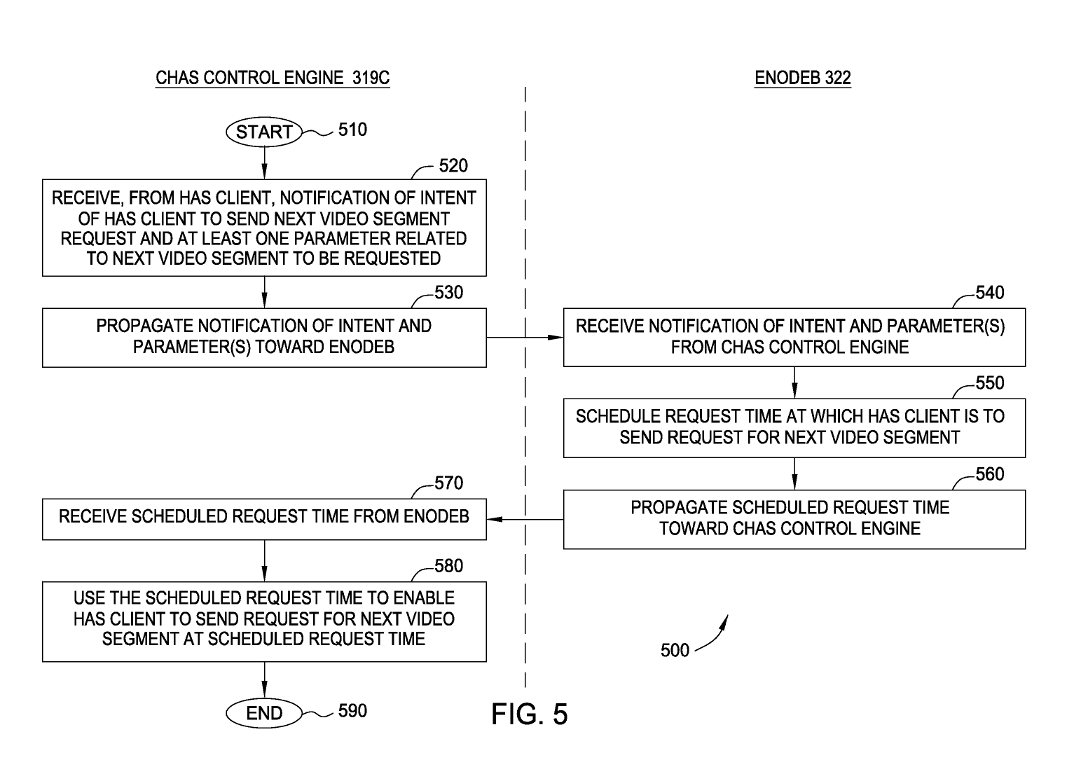

It will be appreciated that, although method 400 enables selection of video bitrates for each of the individual HAS clients of mobile devices, for multiple HAS clients sharing the same wireless link the respective video segments of the HAS clients may arrive at the wireless serving node (e.g., eNodeB 322) at or near the same time. This may create temporary bursts which can exceed the capacity of the wireless link and/or the buffer capacity of the wireless serving node, thereby resulting in packet drops at the cell and, thus, subsequent video segment retransmissions from the HAS video content server 340 which may exacerbate the load conditions on the cell. In at least some embodiments, the system 300 of FIG. 3 may be configured to pace arriving downlink video segments via scheduling of the next video segment requests. An exemplary embodiment is depicted and described with respect to FIG. 5.

FIG. 5 depicts an exemplary embodiment for providing for pacing of downlink video segments via scheduling of the video segment requests. Although primarily depicted and described as being performed serially, it will be appreciated that at least a portion of the steps of method 500 may be performed contemporaneously and/or in a different order than depicted and described with respect to FIG. 5.

It will be appreciated that spacing of arrival of new video segments for different HAS video sessions served by the same cell (i.e., same eNodeB 322) is performed by proper scheduling of the HAS client requests for respective next video segments. It is further noted that the network RRC interface 334₁ between CCE 319_{C} and eNodeBs 322 is utilized for purposes of supporting method 500 of FIG. 5.

At step 510, method 500 begins.

At step 520, prior to HAS client 311 sending a request for a next video segment, CCE 319_{C} receives from HAS client 311 a notification of the intent of HAS client 311 to send a request for a next video segment and at least one parameter related to the next video segment to be requested. The at least one parameter related to the next video segment to be requested may include one or more of a bitrate for the next video segment, a playtime duration for the next video segment, and an expected video segment size for the next video segment. The CCE 319_{C} may receive the notification from HAS client 311 via HAS client Interface 331.

At step 530, CCE 319_{C} propagates the notification by HAS client 311 of its intent to send a request for a next video segment and the parameter(s) related to the next video segment to be requested toward eNodeB 322. At step 540, the eNodeB 322 receives the notification by HAS client 311 of its intent to send a request for a next video segment and the parameter(s) related to the next video segment to be requested. This information may be provided from CCE 319_{C} to eNodeB 322 via network RRC interface 334₁.

At step 550, the eNodeB 322 schedules a request time at which the HAS client 311 is to send the request for the next video segment. The eNodeB 322 may perform such scheduling by monitoring, for some or all of the HAS video sessions that it is currently supporting, the average delay between video segment requests of the monitored HAS video sessions and the arrival of the initial video segments in response to the video segment requests, respectively. The eNodeB 322 may perform such scheduling using any other suitable scheduling mechanisms.

At step 560, the eNodeB 322 propagates the scheduled request time toward CCE 319_{C}. At step 570, the CCE 319_{C} receives the scheduled request time from the eNodeB 322. This information may be provided from eNodeB 322 to CCE 319_{C} via network RRC interface 334₁.

At step 580, CCE 319_{C} uses the scheduled request time to enable the HAS client 311 to send the request for the next video segment at the scheduled request time. In at least some embodiments, the CCE 319_{C} provides the scheduled request time to HAS client 311 via HAS client interface 331 upon receiving the request time from eNodeB 322. In at least some embodiments, the CCE 319_{C} informs HAS client 311, via HAS client interface 331, when the scheduled request time has arrived such that it is now time for the HAS client 311 to send the request for the next video segment. In either case, the HAS client 311 initiates a request for the next video segment at the request time.

At step 590, method 500 ends.

It will be appreciated that, although omitted for purposes of clarity, method 500 of FIG. 5 may be used in conjunction with at least a portion of method 400 of FIG. 4. In at least some embodiments, for example, steps 520-570 of method 500 may be performed after step 450 of FIG. 4 and prior to step 455 of FIG. 4, where steps 455 of FIG. 4 corresponds to the time at which the HAS client 311 initiates a request for the next video segment (on the basis of the process of FIG. 4) at the request timed (as determined via the process of FIG. 5). In at least some embodiments, for example, steps 520-570 of method 500 may be performed contemporaneously with one or more of steps 410-450 of FIG. 4 (and, thus, prior to step 455 of FIG. 4), where steps 455 of FIG. 4 corresponds to the time at which the HAS client 311 initiates a request for the next video segment (on the basis of the process of FIG. 4) at the request timed (as determined via the process of FIG. 5). It is noted that other embodiments are contemplated.

It will be appreciated that, although omitted for purposes of clarity, the functions performed by eNodeB 322 in support of method 500 may be supported by eNodeB 322 in any suitable manner (e.g., by a new CHAS function provided on the eNodeB 322 or in any other suitable manner).

As will be appreciated from descriptions of embodiments of the video session management capability, the video session management capability provides various benefits to the WSP by enabling precise management and control functions for mobile video traffic delivery and user QoE improvement. It will be appreciated that such functions enable the WSP to significantly improve of existing mobile video services and introduce new mobile video services. It is further noted that such functions also enable the WSP to deliver mobile video that is significantly more stable and which has better QoE, thereby enabling monetization of “pay for quality” video services. It is further noted that, by enabling better management of (and, in at least some cases, control over) mobile video traffic, the WSP will be able to deliver reasonably high quality mobile video to more end users.

It will be appreciated that, although primarily depicted and described herein with respect to embodiments in which the video session management capability is used to manage non-encrypted mobile video sessions, various embodiments of the video session management capability also may be used to manage encrypted mobile video sessions.

It will be appreciated that, although primarily depicted and described herein with respect to embodiments in which the video session management capability is utilized within specific types of wireless networks (e.g., cellular networks and Wi-Fi networks), various embodiments of the video session management capability also may be utilized within other types of wireless networks and/or within wired networks.

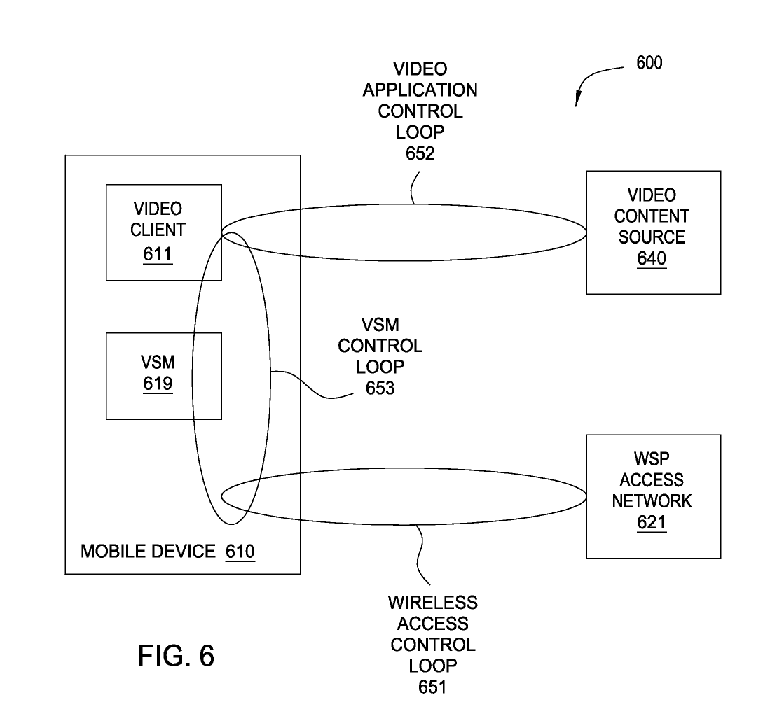

FIG. 6 depicts a high-level control loop diagram for a system configured to manage video sessions over a cellular network.

As depicted in FIG. 6, system 600 includes a mobile device 610, a WSP access network 621, and a video content source 640. The mobile device 610 includes a video client 611 and a VSM 619. In at least some embodiments, for example, system 600 may be considered to be a simplified version of system 100 of FIG. 1 (e.g., with mobile device 610 corresponding to mobile device 110, WSP access network 621 corresponding to cellular network elements 121, and video content source 640 corresponding to video content element 140). In at least some embodiments, for example, system 600 may be considered to be a simplified version of system 300 of FIG. 3 (e.g., with mobile device 610 corresponding to mobile device 310, WSP access network 621 corresponding to cellular network elements 321, and video content source 640 corresponding to HAS video content server 340).

As further depicted in FIG. 6, a pair of control loops is supported between mobile device 610 and network elements. More specifically, a wireless access control loop 651 is provided between mobile device 610 and WSP access network 621 and a video application control loop 652 is provided between video client 610 and video content source 640. Additionally, VSM 619 is configured to support a VSM control loop 653 which binds the wireless access control loop 651 and the video application control loop 652 together at the mobile device 610, thereby providing a double control loop configured to provide consistent mobile video quality for both non-encrypted and encrypted video sessions.

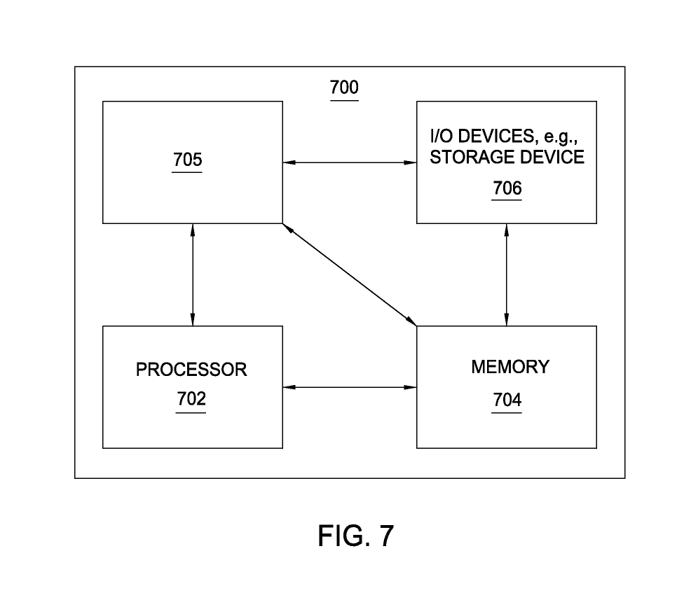

FIG. 7 depicts a high-level block diagram of a computer suitable for use in performing functions described herein.

As depicted in FIG. 7, computer 700 includes a processor element 702 (e.g., a central processing unit (CPU) and/or other suitable processor(s)) and a memory 704 (e.g., random access memory (RAM), read only memory (ROM), or the like). The computer 700 also may include a cooperating module/process 705 and/or various input/output devices 706 (e.g., one or more of a user input device (such as a keyboard, a keypad, a mouse, or the like), a user output device (such as a display, a speaker, or the like), an input port, an output port, a receiver, a transmitter, and a storage device (e.g., a tape drive, a floppy drive, a hard disk drive, a compact disk drive, or the like)).

It will be appreciated that the functions depicted and described herein may be implemented in software (e.g., via implementation of software on one or more processors) and/or may be implemented in hardware (e.g., using a general purpose computer, one or more application specific integrated circuits (ASIC), and/or any other hardware equivalents).

It will be appreciated that the functions depicted and described herein may be implemented in software (e.g., for executing on a general purpose computer (e.g., via execution by one or more processors) so as to implement a special purpose computer) and/or may be implemented in hardware (e.g., using one or more application specific integrated circuits (ASIC) and/or one or more other hardware equivalents).

In at least some embodiments, the cooperating process 705 can be loaded into memory 704 and executed by the processor 702 to implement functions as discussed herein. Thus, cooperating process 705 (including associated data structures) can be stored on a computer readable storage medium, e.g., RAM memory, magnetic or optical drive or diskette, or the like.

It will be appreciated that computer 700 depicted in FIG. 7 provides a general architecture and functionality suitable for implementing functional elements described herein and/or portions of functional elements described herein. For example, the computer 700 provides a general architecture and functionality suitable for implementing one or more of a portion of mobile device 110, mobile device 110, any of the cellular network elements 121, a portion of policy/congestion server 125, a policy/congestion server 125, a portion of VGTE 126, a VGTE 126, a portion of VSM server 129, a VSM server 129, a portion of video content element 140, video content element 140, a portion of mobile device 310, a mobile device 310, any of the cellular network elements 321, a portion of policy/congestion server 325, a policy/congestion server 325, a portion of CHAS server 329, a CHAS server 329, a portion of HAS video content server 340, HAS video content server 340, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or,” unless otherwise indicated (e.g., “or else” or “or in the alternative”).

It will be appreciated that, while the foregoing is directed to various embodiments of features presented herein, other and further embodiments may be devised without departing from the basic scope thereof.

What is claimed is:

1. An apparatus for use at a mobile device comprising a Hypertext Transfer Protocol (HTTP) Adaptive Streaming (HAS) client, the apparatus comprising:
a processor and a memory communicatively connected to the processor, the processor configured to:
propagate, from the mobile device toward a network server, a HAS registration request of a HAS control engine of the mobile device, the HAS control engine configured to support the HAS client of the mobile device, the HAS registration request related to a HAS video session requested by the HAS client of the mobile device;
propagate, from the mobile device toward the network server, HAS manifest information of a HAS manifest file related to the HAS video session requested and client information related to the HAS video session that is obtained at the mobile device; and
receive, at the HAS control engine of the mobile device from the network server, an indication of a recommended bitrate calculated for the HAS video session by the network server using the HAS manifest information, the client information, and network information related to the requested HAS video session obtained by the network server.

2. The apparatus of claim 1, wherein the processor is further configured to:
propagate the recommended bitrate from the HAS control engine toward the HAS client for use by the HAS client to adjust at least one rate determination algorithm (RDA).

3. The apparatus of claim 1, wherein the processor is further configured to:
receive, at the HAS control engine of the mobile device from the network server, at least one HAS video session parameter determined for the HAS video session by the network server using at least one of the HAS manifest information, the client information, and the network information.

4. The apparatus of claim 3, wherein the processor is further configured to:
propagate the at least one HAS video session parameter from the HAS control engine toward the HAS client for use by the HAS client to adjust at least one rate determination algorithm (RDA) of the HAS client.

5. The apparatus of claim 1, wherein the processor is configured to:
receive, from the HAS client, a notification of intent of the HAS client to request a next video segment and at least one parameter associated with the next video segment to be requested;
propagate the notification and the at least one parameter toward a wireless access node of a wireless service provider network associated with the network server; and
receive, at the HAS control engine of the mobile device from the wireless access node, a scheduled request time indicative of a time at which the HAS client is to request the next video segment.

6. The apparatus of claim 5, wherein the at least one parameter associated with the next video segment to be requested comprises at least one of a bitrate for the next video segment and a playtime duration for the next video segment.

7. The apparatus of claim 5, wherein the at least one parameter associated with the next video segment to be requested comprises an expected video segment size for the next video segment.

8. The apparatus of claim 5, wherein the processor is configured to:
propagate the scheduled request time from the HAS control engine toward the HAS client upon receiving the scheduled request time from the wireless access node.

9. The apparatus of claim 5, wherein the processor is configured to:
maintain the scheduled request time at the HAS control engine; and
in response to a determination that the scheduled request time has been reached, initiate from the HAS control engine toward the HAS client an indication that the HAS client is to initiate the request for the next video segment.

10. An apparatus configured to support Hypertext Transfer Protocol (HTTP) Adaptive Streaming (HAS) sessions, the apparatus comprising:
a processor and a memory communicatively connected to the processor, the processor configured to:
receive, at a network server, a HAS registration request from a HAS control engine of a mobile device supporting a HAS client, the HAS registration request related to a HAS video session requested by the HAS client of the mobile device;
receive, at the network server, HAS manifest information of a HAS manifest file related to the requested HAS video session and client information related to the HAS video session that is obtained at the mobile device;
receive, at the network server, network information related to the requested HAS video session;
calculate, at the network server, a bitrate for the requested HAS video session, wherein the bitrate is calculated using the HAS manifest information, the client information, and the network information; and
propagate an indication of the calculated bitrate from the network server toward the mobile device for use by the HAS client with the requested HAS video session.

11. The apparatus of claim 10, wherein the processor is further configured to:
determine, at the network server, at least one HAS video session parameter for the HAS video session, wherein the at least one HAS video session parameter for the HAS video session is determined by the network server using at least one of the HAS manifest information, the client information, and the network information; and
propagate the at least one HAS video session parameter from the network server toward the mobile device for use by the HAS client with the requested HAS video session.

12. An apparatus for use at a mobile device comprising a Hypertext Transfer Protocol (HTTP) Adaptive Streaming (HAS) client, the apparatus comprising:
a processor and a memory communicatively connected to the processor, the processor configured to:
receive, at the mobile device, a bitrate calculated for the HAS client by a network server associated with a network configured to provide wireless access to the mobile device;
adjust a Rate Determination Algorithm (RDA) of the HAS client using the received bitrate; and
run the adjusted RDA of the HAS client to determine a bitrate for a HAS session of the HAS client.

13. The apparatus of claim 12, wherein the processor is configured to receive the bitrate from a HAS control engine of the mobile device.

14. The apparatus of claim 12, wherein the processor is further configured to:
receive, at the mobile device, at least one session parameter determined for the HAS client by the network server; and
adjust the RDA of the HAS client using the at least one session parameter.

15. The apparatus of claim 14, wherein the processor is configured to receive the at least one session parameter from a HAS control engine of the mobile device.

16. An apparatus for use at a mobile device comprising a Hypertext Transfer Protocol (HTTP) Adaptive Streaming (HAS) client, the apparatus comprising:
a processor and a memory communicatively connected to the processor, the processor configured to:
receive, from the HAS client, a notification of intent of the HAS client to request a next video segment for a HAS session of the HAS client and at least one parameter associated with the next video segment to be requested;
propagate the notification and the at least one parameter from the mobile node toward a wireless access node configured to provide wireless access to the mobile device; and
receive, at the mobile device from the wireless access node, a scheduled request time indicative of a time at which the HAS client is to request the next video segment.

17. The apparatus of claim 16, wherein the at least one parameter associated with the next video segment to be requested comprises at least one of a bitrate for the next video segment and a playtime duration for the next video segment.

18. The apparatus of claim 16, wherein the at least one parameter associated with the next video segment to be requested comprises an expected video segment size for the next video segment.

19. The apparatus of claim 16, wherein the scheduled request time is received at a HAS control engine of the mobile device, wherein the processor is configured to:
propagate the scheduled request time from the HAS control engine toward the HAS client upon receiving the scheduled request time from the wireless access node.

20. The apparatus of claim 16, wherein the scheduled request time is received at a HAS control engine of the mobile device, wherein the processor is configured to:
maintain the scheduled request time at the HAS control engine; and
in response to a determination that the scheduled request time has been reached, initiate from the HAS control engine toward the HAS client an indication that the HAS client is to initiate the request for the next video segment.
